(19) United States
(12) Patent Application Publication
(10) Pub. No.: US 2004/0098626 A1
(43) Pub. Date: May 20, 2004

(54) Login method

(76) Inventors: Jari Kuvaja, Espoo (FR); Sakari Molin, Jarvenpaa (FI); Heikki Bayr, Huhmari (FI); Antti Soini, Helsinki (FI); Joona Myllynen, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/473,341

(22) PCT Filed: Apr. 2, 2002
(86) PCT No.: PCT/FI02/00279

(30) Foreign Application Priority Data
Mar. 30, 2001 (FI) 20010667

(51) Int. Cl. H04L 9/00

(52) U.S. Cl. 713/202

(57) ABSTRACT

The invention relates to a method of logging onto at least two network elements within a communications system, in which method a user inputs a first username (GUSER) and a first password (GPSSWD) at a user station (WS); said user station (WS) logs on (2-2) to a first system (NEMU) using said first username (GUSER) and said first password (GPSSWD) through a first connection; said first system (NEMUT) determines (2-10, 2-12, 2-14) a second username (MUSER) and a second password (MPSSWD) in co-operation with a second system (DX); said first system (NEMU) sends (2-18) said second username (MUSER) and said second password (MPSSWD) to said user station (WS); and said user station (WS) logs on (2-20) to said second system (DX) with said second username (MUSER) and said second password (MPSSWD).

### FIELD OF THE INVENTION

The invention relates to a method of logging on to at least two network elements on a protected communications network.

### BACKGROUND OF THE INVENTION

Computer networks typically consist of a virtually unlimited number of individual computers and connections between them. Communication protocols used in inter-system communication between computers do not set any requirements for conversational systems. A telecommunications network is a typical example of computer networks.

Management of a computer network can be carried out by managing network elements individually or by using a network management system enabling concentrated network management—the latter case providing simultaneous management operations in several network elements. Developed network management systems are beneficial especially in telecommunications networks where the number of individual network elements may be considerably high and evolution of the network is rapid but network reliability and service requirements allow hardly any outage time at all in the network.

An increasingly important characteristic of computer networks is security. Global networks can produce global harm in malevolent use. Thus, it is of paramount importance to maintain maximum security in computer networks by making unauthorised access to the network elements as difficult as possible. This target has been addressed e.g. by introducing password protection of user access, encryption of the transmitted and stored data and the separation of user authorisation levels in network management systems.

Efficient network management operations in a computer network often require simultaneous management sessions in several network elements. To launch such sessions a user needs to log in to each of these systems separately, possibly using different usernames and passwords. The network security would be significantly compromised if the same username/password pair could be used in several network elements. Similarly, if the acceptable username/password pairs would be stored in any one location to be used as a center point for all user authentications in the network, a breach into this network element would render the whole network insecure.

Currently the user who wants to log on to two or more individual network elements usually has to use an individual username/password pair for each network element. However, this is a complex way of operating on communications network in which it is desirable to operate fast and reliably.

### BRIEF DESCRIPTION OF THE INVENTION

It is thus an object of the present invention to provide a method and an arrangement for implementing the method so as to overcome the above problem. The object of the invention is achieved by a method and an arrangement, which are characterized by what is stated in the independent claims. The preferred embodiments of the invention are disclosed in the dependent claims.

According to the invention, a user inputs a first username and a first password, which enable a user station to log on to a first system. Then the first system determines a second username and a second password in cooperation with a second system, and sends them to the user station. The user station logs on to the second system with said second username and said second password.

In a preferred embodiment of the invention, the first system determines the second username on the basis of the first username using predetermined mapping information, generates the second password and negotiates an encryption key for the second password with the second system over an inter-system connection. The second password is encrypted with the encryption key by a predetermined algorithm, transferred to the second system and stored temporarily in the second system. The first system sends the second username and the second password to the user station through the first connection. The user station sends them to the second system through a second connection. The second system encrypts the second password received from the user station by means of the encryption key and the predetermined algorithm. The user is logged on to the second system if the encrypted received second password matches with the encrypted second password stored in the second system.

It is an advantage of the method and arrangement of the invention that the user does not have to use two different username/password pairs when logging on to two different systems. One username/password pair provides access to one system, which then provides a second username/password pair for a second system in co-operation with the second system. The processing relating to the username/password pairs is carried out automatically, after the input of the first pair between the user station and the first and second systems. This processing is transparent to the user and gives an illusion that only one logon is made. This facilitates the logging on process. If there are several systems to log onto, one username/password pair provides access to one system, which then provides a required number of second username/password pairs for other systems in co-operation with the other systems.

Another advantage of the invention and its embodiments is that it improves the usability of communications systems by allowing the user to use two different systems without even knowing that s/he has separate identities in these systems.

Still another advantage of the invention and its embodiments is that it improves the data security of the logging on process.

### BRIEF DESCRIPTION OF THE DRAWINGS

In the following the invention will be described in greater detail by means of preferred embodiments with reference to the attached drawings, in which

FIG. 1 illustrates the overall functional environment of the invention; and

FIG. 2 shows a signal chart of using authentication in one embodiment of the invention.

### DETAILED DESCRIPTION OF THE INVENTION

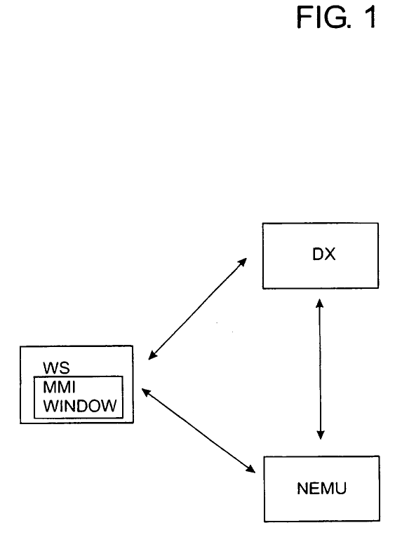

FIG. 1 illustrates the overall functional environment of the feature of the invention. The feature is distributed into three units. These three units are a workstation WS, a communication network element DX and a mediator unit NEMU. A user of WS may be, for example, a network operator who wishes to make a connection both to NEMU and DX in order to, for example, change settings or control data in DX. In a real communications network there may be hundreds of network elements to control in a similar manner as DX shown in FIG. 1.

The user interface resides in the workstation WS, and a part of the authentication goes through the NEMU while the repercussions are ranging in the DX. The user sees an MMI (Man Machine Interface) window basically as one of the EM (Element Manager) applications, which are available in the Application launcher of the WS.

As illustrated in FIG. 1, the invention and its embodiments may also relate to a system, which provides two different connection protocols. One of the protocols may be based on the Telnet, as in FIG. 1, or on the HTTP (Hyper Text Transfer Protocol) protocol or the FTP (File Transfer Protocol) protocol, and the other one may be based on one proprietary message based communication protocol.

In order to connect to both systems according to the state of the art the user has to know the username and the password to both systems and enter the right username/password pair depending on to which system s/he logs on. Alternatively, the system, which makes the first authentication, has to know the valid username/password pair to the second system.

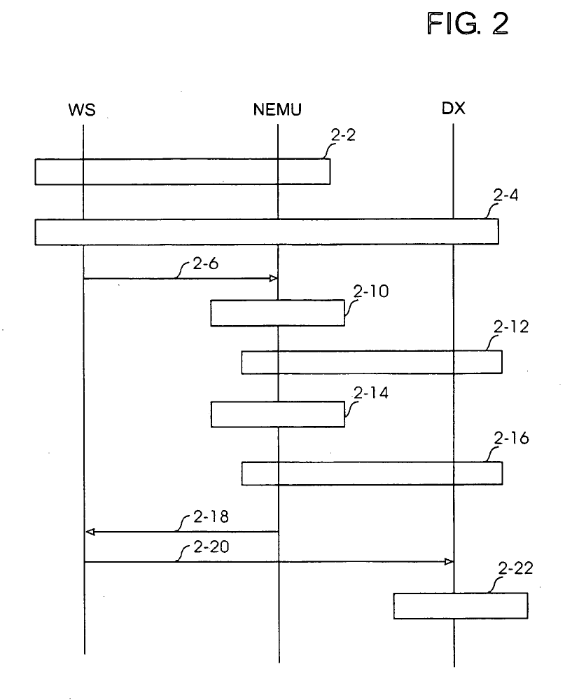

FIG. 2 shows a signalling diagram, which illustrates the authentication in one embodiment of the invention, in which the user gives one username/password pair only once.

In step 2-2 of FIG. 2, the user of WS sends a username/password authentication pair e.g. GUSER/GPSSWD to NEMU element, and NEMU element may respond by a signal indicating that it received said pair.

The user of WS then attempts to open an MMI session in DX (step 2-4). The MMI system will send “Enter Username” and “Enter Password” prompts. Hence a valid MMI Username and some kind of password are needed. In response to the enquiry WS sends a message that the username is not to be sent yet, and the process ID is returned to WS. The process ID of the DX hand is acquired through an ordinary Telnet negotiation process with a proprietary extension.

The workstation then requests from NEMU a username/password (MUSER/MPSSWD) to be used in the MMI session, disclosing the Telnet process ID as a parameter (step 2-6).

In step 2-10, NEMU seeks the musername MUSER corresponding to the GUSER. The comparison between different usernames may be handled by the NEMU, which uses a database comprising e.g. connections between MUSER information and GUSER information, for instance. In this step a temporary password may also be generated by a random number generator, for instance.

In step 2-12 NEMU initiates a connection with DX, asks for an encryption key from DX, which then DX sends the encryption key to NEMU. After that in step 2-14, NEMU encrypts the new password MPSSWD using the encryption key received from DX.

The output of the encryption is then sent in step 2-16 to the corresponding DX hand identified by said ID disclosed in step 2-6. The DX hand receives the output and holds it until a comparison can be made between the two passwords. The original MUSER/MPSSWD text string is sent via Telnet, as will be described below. In step 2-16 said DX element also responds to said NEMU element by a signal indicative that it received the output

In the authentication process via WS to DX, NEMU sends, in step 2-18, the username and the corresponding temporary password MUSER/MPSSWD to WS. In step 2-20, WS replies to the very first DX enquiry of MMI username by sending the authentication pair MUSER/MPSSWD to DX hand.

In step 2-22, the DX hand encrypts the received MPSSWD, as usual, and compares this string with the one received from NEMU. If these two strings match, the DX hand fills the password with an FF element and forwards it with a success status to another hand residing in DX. In case of a failure only an unsuccessful status may be returned. Another element in DX checks if the password is filled with the FF element and decides whether a password check is still needed from the element or not.

When the authentication process in DX hand is finished, the MMI session will be opened between WS and DX. According to the invention the user has thus logged on to two different systems by giving her/his username/password pair only once, which logon is done by means of the user authentication.

It will be obvious to a person skilled in the art that, as the technology advances, the inventive concept can be implemented in various ways. The invention and its embodiments are not limited to the examples described above but may vary within the scope of the claims.

1. A method of logging onto at least two network elements within a communications system, characterized in that
a user inputs (2-2) a first username (GUSER) and a first password (GPSSWD) at a user station (WS);
said user station (WS) logs on (2-2) to a first system (NEMU) using said first username (GUSER) and said first password (GPSSWD) through a first connection;
said first system (NEMU) determines (2-10, 2-12, 2-14) a second; username (MUSER) and a second password (MPSSWD) in co-operation with a second system (DX);
said first system (NEMU) sends (2-18) said second username (MUSER) and said second password (MPSSWD) to said user station (WS);
said user station (WS) logs on (2-20) to said second system (DX) with said second username (MUSER) and said second password (MPSSWD).

2. A method according to claim 1, wherein
said first system (NEMU) determines said second username (MUSER) on the basis of said first username (GUSER) using predetermined mapping information;
said first system (NEMU) generates (2-10) said second password (MPSSWD) and negotiates (2-12) an encryption key for said second password (MPSSWD) with said second system (DX) over an inter-system connection;
said second password (MPSSWD) is encrypted (2-14) with said encryption key by a predetermined algorithm;
said encrypted second password (MPSSWD) is stored (2-16) in said second system (DX);
said first system (NEMU) sends (2-18) said second username (MUSER) and said second password (MPSSWD) to said user station (WS) through said first connection;
said user station (WS) sends (2-20) said second username (MUSER) and said second password (MPSSWD) to said second system (DX) through a second connection;
said second system (DX) encrypts (2-22) said second password (MPSSWD) received from said user station (WS) by means of said encryption key and said predetermined algorithm;
the user is logged onto said second system (DX), if said encrypted received second password (MPSSWD) matches with said encrypted second password stored (MPSSWD) in said second system.

3. A method according to claim 2, wherein said step (2-12) of negotiating comprises steps where
said first system (NEMU) negotiates (2-12) said encryption key with said second system;
said second system generates (2-12) said encryption key;
said first system encrypts (2-14) said second password by means of said encryption key and said predetermined algorithm; and
sends (2-16) said encrypted second password to said second system.

4. A method according any one of claims 1 to 3, wherein
said user station (WS) makes a logon attempt to said second system (DX) in response to said user inputting said first username (GUSER) and said first password (GSSWD);
said second system (DX) responds to said logon attempt by prompting a username and a password;
said user station (WS) carries out said logon to said first system (NEMU) in response to said prompting.

5. A method according to any one of claims 2 to 4, wherein said second password is a random number.

6. An arrangement for logging onto at least two network elements within a communications system, said arrangement comprising
a first system,
a second system, and
a user station having a mechanism for inputting (2-2) a first username (GUSER) and a first password (GPSSWD) at a user station (WS), characterized in that
said user station (WS) is arranged to log on (2-2) to said first system (NEMU) using said first username (GUSER) and said first password (GPSSWD) through a first connection;
said first system (NEMU) is arranged to determine (2-10, 2-12, 2-14) a second username (MUSER) and a second password (MPSSWD) in cooperation with said second system (DX);
said first system (NEMU) is arranged to send (2-18) said second username (MUSER) and said second password (MPSSWD) to said user station (WS); and
said user station (WS) is arranged to log on (2-20) to said second system (DX) with said second username (MUSER) and said second password (MPSSWD).
